(19) United States
(12) Patent Application Publication
(10) Pub. No.: US 2013/0007109 A1
(43) Pub. Date: Jan. 3, 2013

(54) LOAD BALANCING SYSTEM AND METHOD THEREOF

(75) Inventor: Naoki Matsuhira, Kawasaki (JP)

(73) Assignee: FUJITSU LIMITED, Kawasaki-shi (JP)

(21) Appl. No.: 13/542,838

(22) Filed: Jul. 6, 2012

Related U.S. Application Data
(63) Continuation of application No. PCT/JP2010/050049, filed on Jan. 6, 2010.

(51) Int. Cl. G06F 15/16

(52) U.S. Cl. 709/203

(57) ABSTRACT

A load balancing system includes a pre-stage device and a plurality of post-stage devices. The pre-stage device receives original data that has been transmitted from the client device and for which a predetermined server address has been set as the destination address thereof, acquires transfer data having as the destination address thereof an address of any one corresponding post-stage device from among the post-stage devices on the basis of the original data, and transmits the transfer data. The corresponding post-stage device receives the transfer data that has been transmitted from the pre-stage device and which has the address of the corresponding post-stage device as the destination address, restores the transfer data to the original data for which the predetermined server address has been set as the destination address thereof, and transmits the original data to a server device connected to the corresponding post-stage device.

### CROSS-REFERENCE TO RELATED APPLICATION

This is a continuation of application, filed under 35U.S.C. §111(a) of International Application PCT/JP2010/050049, filed on Jan. 6, 2010, the contents of which are herein wholly incorporated by reference.

### FIELD

The present invention relates to a load balancing technology of restraining loads on servers from rising due to accesses from clients.

### BACKGROUND

The load balancing technology is used for the servers that do not provide sufficient performance with only a single server due to a large access count on a network such as the Internet and an Intranet. The load balancing technology actualizes the performance equal to or higher than by the single server in a way that balances (distributes) the loads among a plurality of servers.

Given as the load balancing technology is a technology employing a dedicated apparatus such as a load balancing apparatus. In this technology, clients are connected to the plurality of servers via the load balancing apparatus. The load balancing apparatus distributes the accesses from the client to any one of the plurality of servers disposed at a backend. In this distribution, the load balancing apparatus rewrites a destination address of a packet sent from the client into an address of the distribution target server from an address of the load balancing apparatus itself. Reversely, the load balancing apparatus rewrites a source address of a response packet sent back from the distribution target server into the address of the load balancing apparatus itself from the address of this server.

Further, the load balancing apparatus retains, on the occasion of distributing the packets as described above, an associative relation between the address of the sender client and the rewritten address of the server in order for the packets in the same session to reach the same server. The packets sent from the same client are distributed based on thus-retained associative information to the same server.

Owing to the address translation such as this, though seemingly the client accesses the single server (i.e., one address set in the load balancing apparatus), the accesses from the client are actually distributed to any one of the plurality of servers disposed at the backend of the load balancing apparatus.

### DOCUMENT OF PRIOR ART

### Patent Document

[Patent document 1] Japanese Patent Application Laid-Open Publication No. 2003-281109

### SUMMARY

In the load balancing technology involving the address translation described above, however, a specified application does not normally run as the case may be. This specified application is exemplified by an application of notifying of a destination IP (Internet Protocol) address as in a protocol utilized for IP telephony such as FTP (File Transfer Protocol) and SIP (Session Initiation Protocol) on an application layer. This type of specified application does not normally run as the case may be because of discrepancy between the IP address notified on the application layer and the IP address in an IP header if the IP address in the IP header is rewritten for the load balancing.

Further, the conventional load balancing technology is not applied to a network using IPSec (Security Architecture for Internet Protocol). This is because the packet transmitted from the client as a communication terminal on a transmission side is received by the server as a communication terminal on a reception side in such a status that the IP address different from the IP address set when transmitted is set, and therefore the IP address translation for the load balancing is applicable to falsification. This disables the conventional load balancing technology from utilizing a function of detecting the falsification of the packet by use of IPSec-based AH (Authentication Header).

Further, in the case of using IPSec-based ESP (Encapsulating Security Payload), the packet is encrypted, and hence it is unfeasible to apply the load balancing that employs items of information (a port number etc) of a transport header.

A first aspect relates to a load balancing system having: a pre-stage device to have setting of a predetermined server address; and a plurality of post-stage devices to connect each with the pre-stage device in a communication-enabled manner and to connect respectively with server devices in which predetermined server addresses are individually set. In the load balancing system according to the first aspect, the pre-stage device includes: first receiving unit to receive original data transmitted from the client device and containing the setting of the predetermined server address as a destination address; selecting unit to select any one of target post-stage devices from within the plurality of post-stage devices in a way that corresponds to an address of the client device which is set as a source address in the original data; acquiring unit to acquire transfer data in which an address of the target post-stage device selected by the selecting unit on the basis of the original data is set as the destination address; and first transmitting unit to transmit the transfer data. The target post-stage device includes: second receiving unit to receive the transfer data, transmitted from the pre-stage device, in which an address of the target post-stage device itself is set as the destination address; restoring unit to restore the transfer data received by the second receiving unit back to the original data in which the predetermined server address is set as the destination address; and second transmitting unit to transmit the original data restored by the restoring unit to the server device connected to the target post-stage device itself.

It is noted that a method for realizing the above configuration, a program, a non-transitory computer-readable storage medium recorded with this program, etc may also be given by way of other aspects of the present invention.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a view illustrating a system architecture of a load balancing system in a first working example.

FIG. 2 is a block diagram illustrating an outline of a configuration of a pre-stage device 10 in the first working example.

FIG. 3 is a block diagram illustrating an outline of a configuration of each of post-stage devices 20 in the first working example.

FIG. 4 is a diagram depicting a first example of packets that are load-balanced by the load balancing system in the first working example.

FIG. 5 is a diagram depicting a second example of the packets that are load-balanced by the load balancing system in the first working example.

FIG. 6 is a block diagram illustrating an outline of a configuration of the pre-stage device 10 in a second working example.

FIG. 7 is a block diagram illustrating an outline of a configuration of each of the post-stage devices 20 in the second working example.

FIG. 8 is a diagram illustrating an example of how the packets are load-balanced by the load balancing system in the second working example.

FIG. 9 is a view illustrating a system architecture of the load balancing system in a third working example.

FIG. 10 is a block diagram illustrating an outline of a configuration of the pre-stage device 10 in the third working example.

### DESCRIPTION OF EMBODIMENTS

A load balancing system will hereinafter be described by way of one embodiment by giving a specific example. The load balancing system given as the embodiment is an exemplification related to the load balancing system which restrains a load on a server from rising due to accesses from clients. Working examples given as below are each exemplifications, and the present disclosure is not limited to configurations of the respective working examples that follow.

### First Working Example

A first working example of the load balancing system given as the embodiment will hereinafter be described.

[System Architecture]

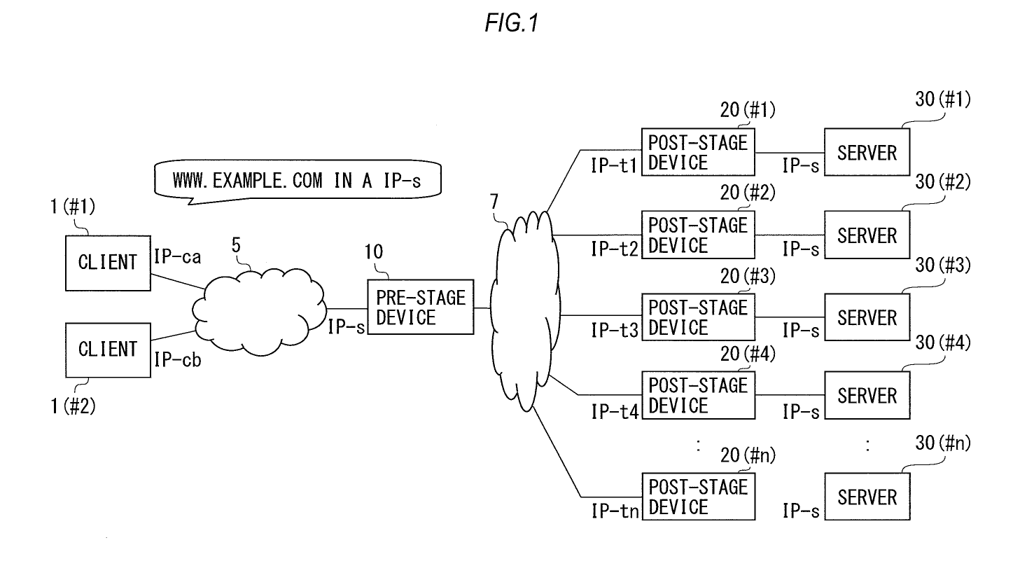

FIG. 1 illustrates a system architecture of the load balancing system in the first working example. The load balancing system in the first working example includes a pre-stage device 10, post-stage devices 20(#1) through 20(#n) and server devices (which will hereinafter be simply referred to as the servers) 30(#1) through 30(#n). Hereafter, unless otherwise required to specify the individual device, the notations with parentheses are omitted, and the post-stage devices and the server devices will be generically expressed such as the post-stage device 20 and the server 30 in singular form.

The number of how many post-stage devices 20 are installed is determined corresponding to the number of the servers 30. One post-stage device 20 is connected to one server 30. For example, as depicted in FIG. 1, the post-stage device 20(#1) is connected to the server 30(#1), and the post-stage device 20(#n) is connected to the server 30(#n). The embodiment does not, however, limit the number of the post-stage devices 20 and the number of the servers 30.

The pre-stage device 10 is connected to an IP network 5 such as the Internet in a communication-enabled manner. Through this connection, the load balancing system in the first working example connects with client devices (which will hereinafter be simply termed the clients) 1(#1) and 1(#2) via the IP network 5. Further, the pre-stage device 10 is connected via an IP network 7 to the post-stage device 20. Other devices excluding the post-stage device 20 may also be connected to the IP network 7. Moreover, the IP network 7 may also be a Layer-2 network such as the Ethernet (registered trademark) etc. The IP network 7 will hereinafter be referred to as the internal IP network 7 in the sense of representing the network for establishing the connection between the pre-stage device 10 and the post-stage device 20.

The embodiment gives an exemplification of using the IP protocol as the protocol utilized between respective nodes, and therefore the nodes each have IP addresses. Note that the embodiment does not restrict the protocol to be utilized if being the protocol configured so that each node has the address.

The same IP address (IP-s) is set in each of the pre-stage device 10 and the server 30. The IP addresses different from each other are set in the respective post-stage devices 20. To be specific, as illustrated in FIG. 1, the post-stage device 20(#1) has the IP address notated by IP-t1, the post-stage device 20(#2) has the IP address “IP-t2”, the post-stage device 20(#3) has the IP address “IP-t3”, the post-stage device 20(#4) has the IP address “IP-t4”, and the post-stage device 20(#n) has the IP address “IP-tn”.

With this IP address configuration, it follows that the two different nodes (the pre-stage device 10 and one server 30 connected to the post-stage device 20 posterior to this pre-stage device 10) having the same IP addresses (IP-s) exist with respect to each post-stage device 20. Peculiarity of this type of IP address configuration is absorbed by the pre-stage device 10 and each post-stage device 20.

[Device Configuration]

A device configuration of each of the nodes related to the load balancing system in the first working example will hereinafter be described.

[Client and Server]

A client 1 is realized by a computer equipped with a CPU (Central Processing Unit), a memory, an input/output (I/O) interface, etc. The computer is exemplified such as a personal computer, a mobile phone and a PDA (Personal Digital Assistant). The client 1 in the first working example is sufficient if having a communication function for implementing the IP protocol, but other functions of the client 1 are not restricted. Note that if the client 1 is realized as a mobile terminal, the client 1 is connected to the IP network 5 via a base station (unillustrated) etc. Only two clients 1(#1) and 1(#2) are illustrated in FIG. 1, however, the embodiment does not limit the number of the clients which access the present load balancing system.

The client 1 accesses the server 30 as a target server for a load balancing process executed by the load balancing system in the first working example, and requests the server 30 for a predetermined process. The client 1 performs WEB browsing, in which case the client 1 requests the server 30 to provide a predetermined WEB page via a WEB browser. Further, the client 1 transfers a file, in which case the client 1 requests the server 30 to provide a predetermined file.

The server 30 is realized by the computer equipped with the CPU (Central Processing Unit), the memory, the I/O interface, etc. The computer is realized by a general-purpose computer such as the personal computer or by a dedicated computer. The server 30 is sufficient if having a function of executing the process requested by the client 1 and sending response data in response to this request back to the client 1. Further, the embodiment does not restrict a content of the process requested by the client 1. The server 30 is exemplified such as a WEB server and a file server.

[Pre-Stage Device]

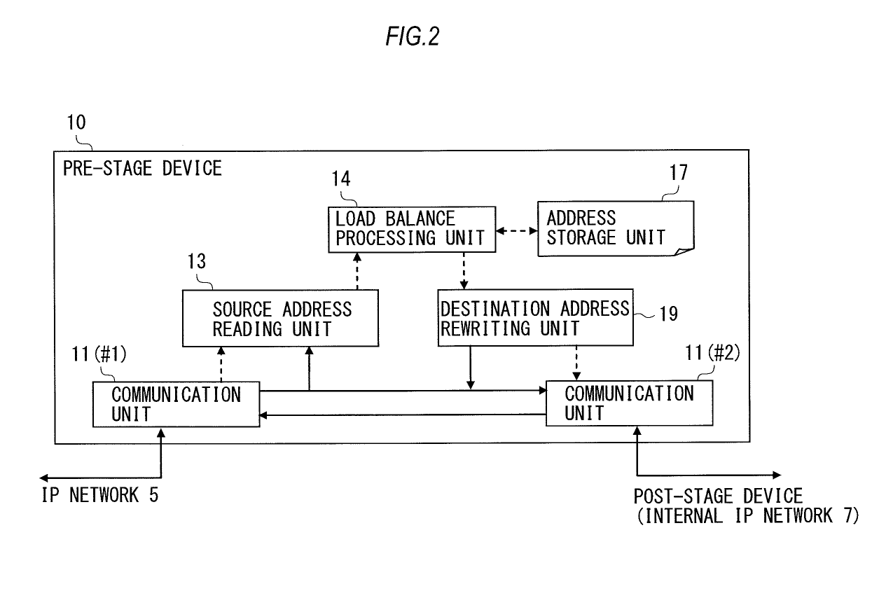

FIG. 2 is a block diagram illustrating an outline of a configuration of the pre-stage device 10 in the first working example. The pre-stage device 10 in the first working example includes communication units 11(#1) and 11(#2), a source address reading unit 13, a load balance processing unit 14, an address storage unit 17, a destination address rewriting unit 19, etc. These respective units of the pre-stage device 10 are each realized by software components or hardware components or combinations thereof (refer to Paragraph [Others]). These respective units are each connected in the communication-enabled manner.

The communication units 11(#1) and 11(#2) have communication ports different from each other. The communication port of the communication unit 11(#1) is connected to a communication line linked with the IP network 5. The communication port of the communication unit 11(#2) is connected to a communication line linked with the plurality of post-stage devices 20 via the internal IP network 7.

The communication unit 11(#1), when receiving a packet that contains setting of the IP address (IP-s) of the self-device (pre-stage device 10) from the IP network 5, notifies the source address reading unit 13 of the reception of this packet. Reversely, the communication unit 11(#1), when the communication unit 11(#2) receives the packet from the internal IP network 7, forwards this received packet to the IP network 5.

The communication unit 11(#2) receives the packet sent from the internal IP network 7. The communication unit 11(#2) sends the received packet to the communication unit 11(#1). The communication unit 11(#2) receives the packet transmitted by the post-stage device 20. The IP address of the client 1 is set in the “destination address” field of the packet sent from the post-stage device 20. Reversely, the communication unit 11(#2), upon receiving an instruction from the destination address rewriting unit 19, sends, to the internal IP network 7, the packet containing the destination address rewritten by the destination address rewriting unit 19.

The source address reading unit 13, when receiving the notification of receiving the packet from the communication unit 11(#1), reads the source address set in an IP header of the received packet. The thus-read source IP address is sent to the load balance processing unit 14.

The load balance processing unit 14, when receiving the source IP address from the source address reading unit 13, determines whether or not execution of the load balancing process of the packet sent from this source IP address is underway-status of the execution. Specifically, the load balance processing unit 14 determines whether or not the source IP address given from the source address reading unit 13 is stored in the address storage unit 17. If the source IP address is stored in the address storage unit 17, this indicates the underway-status of the execution of the load balancing process of the packet sent from this source IP address. The “underway-status of the execution of the load balancing process” connotes a status in which the post-stage device 20 that the pre-stage device 10 forwards the packet sent from the source IP address to has already been determined. Whereas if the source IP address is not stored in the address storage unit 17, this indicates that the load balancing process of the packet sent from this source IP address is not yet executed.

The load balance processing unit 14, when determining that the load balancing process of the packet sent from this source IP address is in the underway-status of the execution, acquires the IP address of the already-determined post-stage device 20. To be specific, the load balance processing unit 14, if the source IP address is stored in the address storage unit 17, extracts the destination address stored in the way of being associated with the source IP address from the address storage unit 17. The load balance processing unit 14 sends the extracted destination address to the destination address rewriting unit 19.

While on the other hand, the load balance processing unit 14, when determining that the load balancing process of the packet sent from this source IP address is not executed, selects the post-stage device 20 that the pre-stage device 10 forwards the packet sent from this source IP address to from within the post-stage devices 20(#1) through 20(#n). This selection has the same meaning as determining which server 30 the access from the client 1 specified by the source IP address is distributed to. The load balance processing unit 14 selects the post-stage device 20 as an distribution target device on the basis of the source IP address.

This selection method is such that the post-stage device 20 is selected as the distribution target device on the basis of an arbitrary bit position and a value indicated by an arbitrary bit count of the source IP address. For example, when the number of the servers 30 (the post-stage devices 20) is 16, the post-stage device 20 is selected as the distribution target device by the value of the arbitrary 4 bits. Another selection method is that a sequence of the respective servers 30 is previously determined, and the post-stage device 20 is selected as the distribution target device according to this sequence. Further, states of the loads on the servers 30 are respectively monitored, and the post-stage device 20 connected to the server 30 with a low load may also be selected corresponding to the states of the loads on the respective servers 30. In the first working example, if the post-stage device 20 serving as the distribution target device is selected based on the source IP address, a detailed selection method thereof is not restricted.

The load balance processing unit 14, when any one of the post-stage devices 20 is selected as the post-stage device 20 becoming the distribution target device, an entry containing the IP address of the selected post-stage device 20 and the target source IP address is stored in the address storage unit 17. The load balance processing unit 14 sends the IP address of the thus-selected post-stage device 20 to the destination address rewriting unit 19.

The address storage unit 17 gets stored with the entry containing the source IP address set in the packet received by the communication unit 11(#1) and the IP address of the post-stage device 20 determined as the distribution target device by the load balance processing unit 14 with respect to this packet. Each of the entries stored in the address storage unit 17 may be deleted if a continuous period of time for which any reference to this entry is not made (the duration of non-reference) exceeds a predetermined period of time. In this case, an available scheme is that each entry contains the duration of reference.

The destination address rewriting unit 19, when receiving the IP address of the post-stage device 20 from the load balance processing unit 14, rewrites the destination address stored in the IP header of the packet received by the communication unit 11(#1) into the IP address of the post-stage device 20. The destination address rewriting unit 19, upon an end of rewriting the destination address, requests the communication unit 11(#2) to transmit the packet with the address being rewritten. Note that if the internal IP network 7 is the Layer-2 (L2) network such as the Ethernet (registered trademark), the destination address rewriting unit 19 may not, on the occasion of rewriting the destination IP address, recalculate a checksum of the IP header of this packet. This is because, as will be mentioned later on, the destination IP address rewritten by the pre-stage device 10 is written back to the original address by the post-stage device 20 with the result that no contradiction occurs in the packet received by the server 30. If the internal IP network 7 is the IP network, however, the destination address rewriting unit 19 recalculates the checksum. This is because, in the case of the IP network, (a value of) TTL (Time To Live) in IPv4 and (a hop count of) Hop Limit in IPv6 change in transitional routers.

[Post-Stage Device]

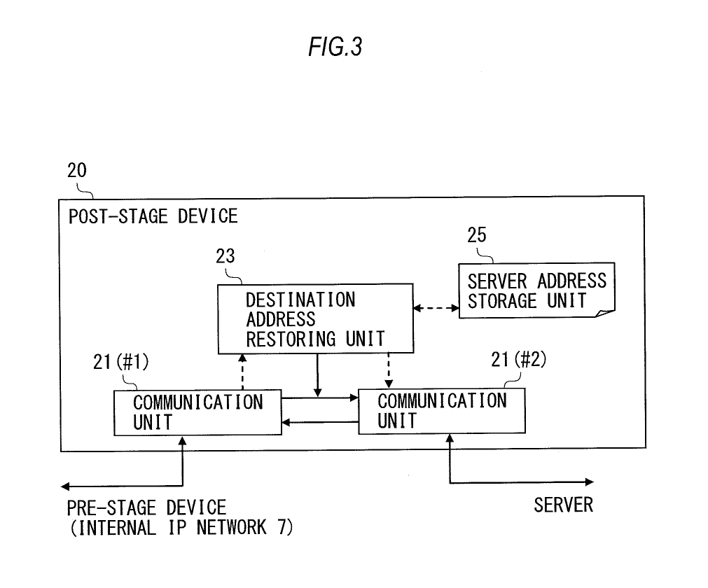

FIG. 3 is a block diagram illustrating an outline of a configuration of each post-stage device 20 in the first working example. Each of the post-stage devices 20 has the same configuration.

The post-stage device 20 in the first working example includes communication units 21(#1) and 21(#2), a destination address restoring unit 23, a server address storage unit 25, etc. These respective units of the post-stage device 20 are each realized by software components or hardware components or combinations thereof (refer to Paragraph [Others]). These respective units are each connected in the communication-enabled manner.

The communication units 21(#1) and 21(#2) have communication ports different from each other. The communication port of the communication unit 21(#1) is connected to a communication line linked with the pre-stage device 10 via the internal IP network 7. The communication port of the communication unit 21(#2) is connected to a communication line linked with any one of the plurality of servers 30. The communication unit 21(#1) and 21(#2) have the IP addresses for the post-stage devices 20. For instance, the communication units 21(#1) and 21(#2) of the post-stage device 20(#n) have the IP addresses (IP-tn), and the communication unit 21(#2) of the post-stage device 20(#n) is connected to the communication line linked with the server 30(#n).

The communication unit 21(#1), when receiving the packet containing the setting of the IP address (e.g., IP-tn) of the self-device (the post-stage device 20) from the internal IP network 7, notifies the destination address restoring unit 23 that the packet has just been received. Reversely, the communication unit 21(#1), when the communication unit 21(#2) receives the packet transmitted from the server 30, sends this received packet to the internal IP network 7.

The communication unit 21(#2), when receiving the packet transmitted from the server 30 connecting with the self-device (the post-stage device 20), sends this packet to the communication unit 21(#1). The communication unit 21(#1), as described above, forwards this packet to the internal IP network 7. Note that the IP address of the client 1 is set in the “destination address” field of the packet sent from the server 30. Reversely, the communication unit 21(#2), upon receiving the instruction from the destination address restoring unit 23, sends the packet with the destination address being written back (restored) to the original address by the destination address restoring unit 23 to the server 30.

The destination address restoring unit 23, when receiving the notification of the reception of the packet from the communication unit 21(#1), restores the destination address of this received packet back to the IP address that is originally set before being rewritten by the pre-stage device 10. The IP address, which is originally set before being rewritten by the pre-stage device 10, is the IP address (IP-s) of the server 30. Further, the pre-stage device 10 rewrites, the destination address of the packet addressed to the self-device (the post-stage device 20) into the IP address of the self-device. Accordingly, the destination address restoring unit 23 rewrites the destination address of the packet received by the communication unit 21(#1) into the IP address of the server 30, thereby restoring the destination address back to the IP address that is originally set before being rewritten by the pre-stage device 10. At this time, the destination address restoring unit 23, if the internal IP network 7 is the L2 network and if the destination address rewriting unit 19 of the pre-stage device 10 does not recalculate the checksum, does not similarly recalculate the checksum of the IP header. If the internal IP network 7 is the IP network, however, the destination address restoring unit 23 recalculates the checksum.

The IP address of the server 30 is stored in the server address storage unit 25.

### Operational Example

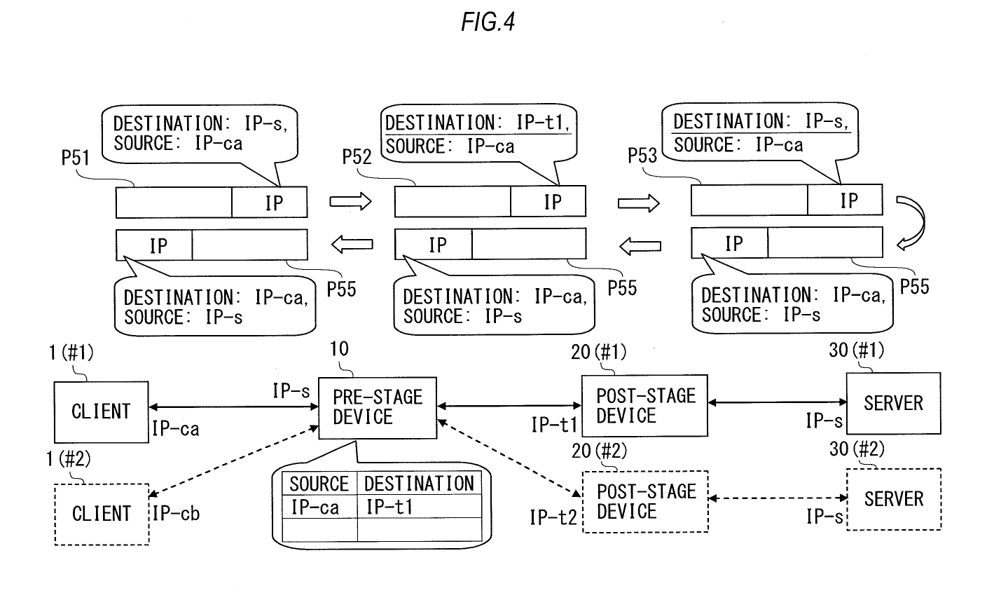

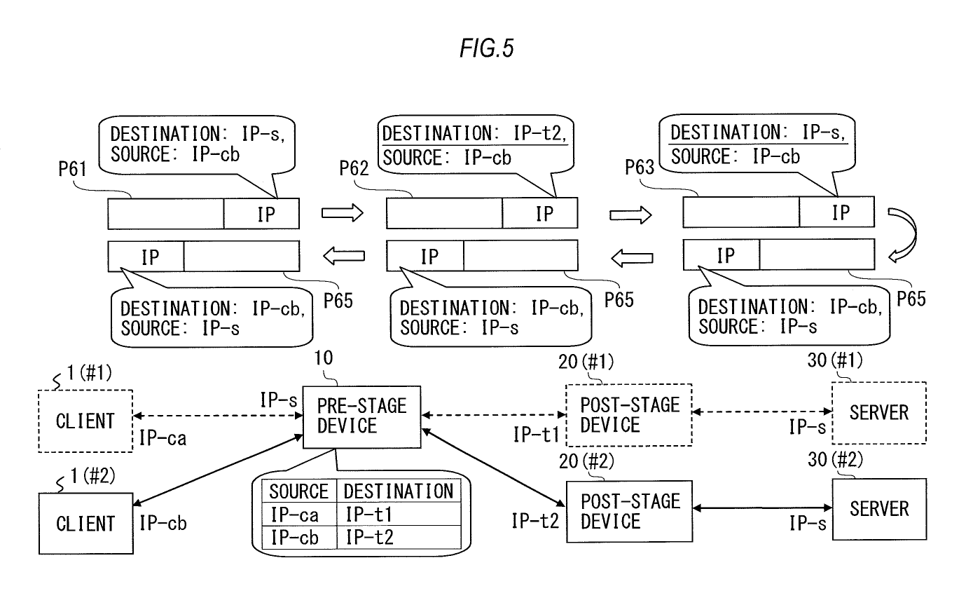

An operational example of the load balancing system in the first working example will hereinafter be described by use of FIGS. 4 and 5. FIG. 4 is a diagram depicting a first example of the packets that are load-balanced by the load balancing system in the first working example. FIG. 5 is a diagram depicting a second example of the packets that are load-balanced by the load balancing system in the first working example.

FIG. 4 illustrates an example in such an instance that the client 1(#1) accesses and requests the server 30 for a predetermined process. According to the example of FIG. 4, the client 1(#1) transmits a packet P51 having the IP header in which the IP address (IP-s) of the server 30 is set in the “destination address” field, and the IP address (IP-ca) of the client 1(#1) itself is set in the “source address” field. This packet P51 is received by the pre-stage device 10 having the same IP address (IP-s) as the IP address of the server 30.

The pre-stage device 10, when the communication unit 11(#1) receives the packet P51 via the IP network 5, notifies the source address reading unit 13 that the packet has been received. The source address reading unit 13 receives this notification and reads the source address from the IP header of the received packet P51.

The load balance processing unit 14, when receiving the thus-read source IP address, searches for the entry containing this source IP address from the address storage unit 17. Herein, an assumption is that the entry containing this source IP address is not stored in the address storage unit 17. In this case, the load balance processing unit 14, when determining that the entry containing this source IP address is not stored in the address storage unit 17, selects the server for processing the packet P51 from within the servers 30(#1) through 30(#n) by use of the source IP address. Herein, it is assumed that the server 30(#1) is selected. The load balance processing unit 14 acquires the IP address (IP-t1) of the post-stage device 20(#1) connected to the selected server 30(#1). The load balance processing unit 14 stores, in the address storage unit 17, the entry containing the acquired IP address (IP-t1) of the post-stage device 20(#1) and the source IP address (IP-ca), and sends the acquired IP address (IP-t1) to the destination address rewriting unit 19.

The destination address rewriting unit 19 rewrites the destination address in the IP header of the packet P51 received by the communication unit 11(#1) into the IP address (IP-t1) received from the load balance processing unit 14. The communication unit 11(#2) receives the instruction from the destination address rewriting unit 19 and sends a packet P52 with its destination address being rewritten by the destination address rewriting unit 19 to the internal IP network 7.

In the packet P52 sent from the pre-stage device 10, the IP address (IP-t1) of the post-stage device 20(#1) is set in the “destination address” field of the IP header thereof, and the IP address (IP-ca) of the client 1(#1) is set in the “source address” field of this IP header. The packet P52 is received by the post-stage device 20(#1) having the IP address (IP-t1) in the post-stage devices 20 (#1) through 20(#n).

In the post-stage device 20(#1), when the communication unit 21(#1) receives the packet P52 via the internal IP network 7, the destination address restoring unit 23 is notified of the reception of the packet. The destination address restoring unit 23 receives this notification and rewrites the destination address in the IP header of the received packet P52 into the IP address (IP-s) of the server 30, which is stored in the server address storage unit 25. In this packet P53, it follows that the destination address in the IP header is written back (restored) to the address (IP-s) set in the original packet P51 from the address (IP-t1) rewritten by the pre-stage device 10. The destination IP address is, though rewritten by the pre-stage device 10, written back to the original address by the post-stage device 20(#1), and hence the packet P53 is the same as the original packet P51. Note that the IP address (IP-ca) of the client 1(#1) is set in the “source address” field in the IP header of the packet P53.

The communication unit 21(#2) sends the packet P53 with its destination IP address being rewritten by the destination address restoring unit 23 to the communication line to which the server 30(#1) is connected. Only the server 30(#1) in the plurality of servers is connected to the communication unit 21(#2) of the post-stage device 20(#1), and therefore the packet P53 is received by the server 30(#1).

The server 30(#1) receives the packet P53 and executes a process corresponding thereto. Subsequently, the server 30(#1) transmits a response packet P55 to the sender of the packet P53. In the response packet P55, the IP address (IP-ca) set as the source IP address of the packet P53 is set in the “destination address” field of the IP header thereof, and the address (IP-s) of the server 30(#1) is set in the “source address” field of the IP header.

This response packet P55 is received by the post-stage device 20(#1) functioning as a router for the server 30(#1). In the post-stage device 20(#1), the communication unit 21(#2), when receiving the packet P55, forwards this response packet P55 to the communication unit 21(#1). The communication unit 21(#1) sends the response packet P55 forwarded from the communication unit 21(#2) to the internal IP network 7.

The response packet P55 is received by the pre-stage device 10 functioning as the router for the post-stage device 20(#1). In the pre-stage device 10, the communication unit 11(#2) connected to the internal IP network 7, when receiving the response packet P55, forwards this received packet P55 to the communication unit 11(#1). The communication unit 11(#1) sends, to the IP network 5, the response packet P55 forwarded from the communication unit 11(#2).

The response packet P55 is forwarded respectively by the post-stage device 20(#1) and by the pre-stage device 10, and hence the source address and the destination address each set in the IP header thereof remain in an as-is status when this packet P55 is transmitted by the server 30(#1). As a result, the client 1(#1) receives the response packet P55 on the basis of the destination IP address (IP-ca) of the response packet P55.

Thus, in the load balancing system in the first working example, the packet addressed to the server 30, which has been transmitted from the client 1(#1), is received by the pre-stage device 10 having the same address (IP-s) as the address of the server 30 becoming the load balance target server. The destination IP address of the packet received by the pre-stage device 10 is rewritten into the address (IP-t1) of the post-stage device 20(#1) connecting with the server 30(#1) to which the processing of this packet is distributed. The packet with its destination IP address being rewritten is forwarded to the server 30(#1) after the post-stage device 20(#1) has written the destination address thereof back to the originally-set server address (IP-s).

The packet received by the server 30(#1), which performs the actual process, becomes the very packet transmitted from the client 1(#1).

Accordingly, the load balancing system in the first working example can normally load-balance traffics of specified applications in which the destination IP addresses are mutually notified on an application layer. Further, also in a system which utilizes AH (Authentication Header) of IPSec (Internet Protocol Security), the packet is prevented from being falsified between the communication terminal on the transmission side and the communication terminal on the reception side, so that it is feasible to apply the load balancing system in the first working example. Namely, according to the first working example, it is possible to realize the general-purpose load balance utilizable in a variety of environments without depending on the applications and the protocols as well.

By the way, the client 1(#1) receiving the packet P55 retransmits the packet to the server 30, in which case this packet is forwarded to the same server 30(#1). In this case, the load balance processing unit 14 of the pre-stage device 10 searches the address storage unit 17 for the entry containing the source IP address (IP-ca), and rewrites the destination address of the packet with the address (IP-t1) of the post-stage device 20(#1) that is contained in this entry.

The access to the server from the same client can be thereby distributed to the same server 30.

FIG. 5 illustrates an example in such a case that the client 1(#2) accesses and requests the server 30 for a predetermined process. According to the example of FIG. 5, the client 1(#2) transmits a packet P61 having the IP header in which the IP address (IP-s) of the server 30 is set in the “destination address” field, and an IP address (IP-cb) of the client 1(#2) itself is set in the “source address” field. This packet P61 is, similarly to the example in FIG. 4, received by the pre-stage device 10 having the same IP address (IP-s) as the IP address of the server 30.

In the pre-stage device 10, similarly to the example in FIG. 4 given above, when the communication unit 11(#1) receives the packet P61, the source address reading unit 13 reads the source IP address (IP-cb) from the IP header of the received packet P61.

The load balance processing unit 14, upon receiving the thus-read source IP address, searches the address storage unit 17 for the entry containing the source IP address (IP-cb). Herein, a presumption is that the address storage unit 17 is stored with only the entry containing the source IP address (IP-ca) as in the example of FIG. 4 but not stored with other entries. In this case, the load balance processing unit 14 selects the server for processing the packet P61 from within the servers 30(#1) through 30(#n) by use of the source IP address (IP-cb) thereof. Herein, it is presumed that the server 30(#2) is selected. The load balance processing unit 14 acquires the IP address (IP-t2) of the post-stage device 20(#2) connected to the selected server 30(#2). The load balance processing unit 14 stores, in the address storage unit 17, the entry containing the acquired IP address (IP-t2) of the post-stage device 20(#2) and the source IP address (IP-cb), and sends the acquired IP address (IP-t2) to the destination address rewriting unit 19.

The destination address rewriting unit 19 rewrites the destination address in the IP header of the packet P61 received by the communication unit 11(#1) into the IP address (IP-t2) received from the load balance processing unit 14. As a result, the communication unit 11(#2) sends a packet P62 with its destination address being rewritten by the destination address rewriting unit 19 to the internal IP network 7.

In the packet P62 sent from the pre-stage device 10, the IP address (IP-t2) of the post-stage device 20(#2) is set in the “destination address” field of the IP header thereof, and the IP address (IP-cb) of the client 1(#2) is set in the “source address” field of this IP header. This packet P62 is received by the post-stage device 20(#2) having the IP address (IP-t2).

In the post-stage device 20(#2), when the communication unit 21(#1) receives the packet P62 via the internal IP network 7, the destination address restoring unit 23 rewrites the destination address of the IP header of the received packet P62 into the IP address (IP-s) of the server 30, which is stored in the server address storage unit 25. The same IP address is set in all of the servers 30(#1) through 30(#n), and therefore, also in the example of FIG. 5, the address is rewritten into the same IP address (IP-s) as in the example of FIG. 4.

In this packet P63, it follows that the destination address in the IP header is written back (restored) to the address (IP-s) set in the original packet P61 from the address (IP-t2) rewritten by the pre-stage device 10. Note that the IP address (IP-cb) of the client 1(#2) is set as it is in the “source address” field in the IP header of the packet P63.

The communication unit 21(#2) sends the packet P63 with its destination IP address being rewritten by the destination address restoring unit 23 to the communication line to which the server 30(#2) is connected. Only the server 30(#2) in the plurality of servers is connected to the communication unit 21(#2) of the post-stage device 20(#2), and therefore the packet P63 is received by the server 30(#2).

Hereafter, the response packet P65 transmitted to the client 1(#2) from the server 30(#2) is, without undergoing the address translation in the same way as in the example of FIG. 4, delivered to the client 1(#2) via the post-stage device 20(#2) and the pre-stage device 10.

Thus, in the load balancing system in the first working example, the packet addressed to the server 30, which has been transmitted from the client 1(#1), is distributed to any one of the plurality of servers 30 on the basis of the source IP address (the address of the client).

### Second Working Example

A second working example of the load balancing system given by way of the embodiment will hereinafter be described. In the first working example discussed above, the packet is distributed to the server in a way that rewrites the destination IP address. In the second working example, the packet is distributed to the server in a way that encapsulates the packet with a specified header.

The system architecture in the second working example is the same as the architecture in the first working example, and the configurations of the client 1 and the server 30 are also the same as those in the first working example. The load balancing system in the second working example will be described by focusing on contents different from those in the first working example.

[Pre-Stage Device]

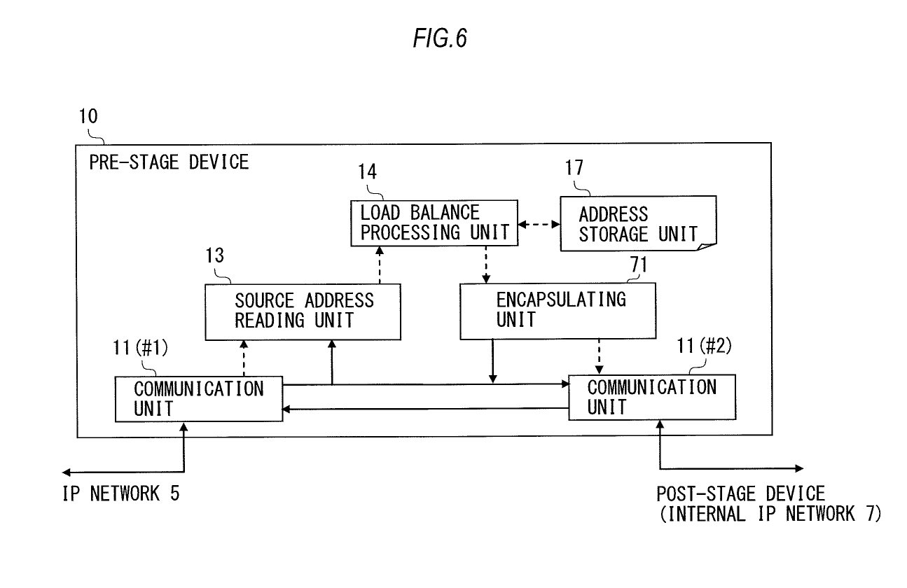

FIG. 6 is a block diagram illustrating an outline of a configuration of the pre-stage device 10 in the second working example. The pre-stage device 10 in the second working example includes an encapsulating unit 71 in place of the destination address rewriting unit 19 in the first working example. Other units included in the pre-stage device 10 are the same as those in the first working example. The encapsulating unit 71 is realized by a software component or a hardware component or a combination thereof, respectively (refer to Paragraph [Others]).

The encapsulating unit 71, upon receiving the IP address of the post-stage device 20 from the load balance processing unit 14, adds a new IP header to this packet without adding any change to the packet received by the communication unit 11(#1). In other words, the encapsulating unit 71 encapsulates the packet received by the communication unit 11(#1) by use of the new IP header. The encapsulating unit 71 sets the IP address of the post-stage device 20 in the “destination address” field of this new IP header. Note that the same address as the source IP address of the original packet may be set in the “source address” field of the new IP header, and the IP address of the pre-stage device 10 (the IP address of the server 30) may also be set in this “source address” field. The encapsulating unit 71, when finishing the encapsulation, requests the communication unit 11(#2) to transmit the encapsulated packet.

[Post-Stage]

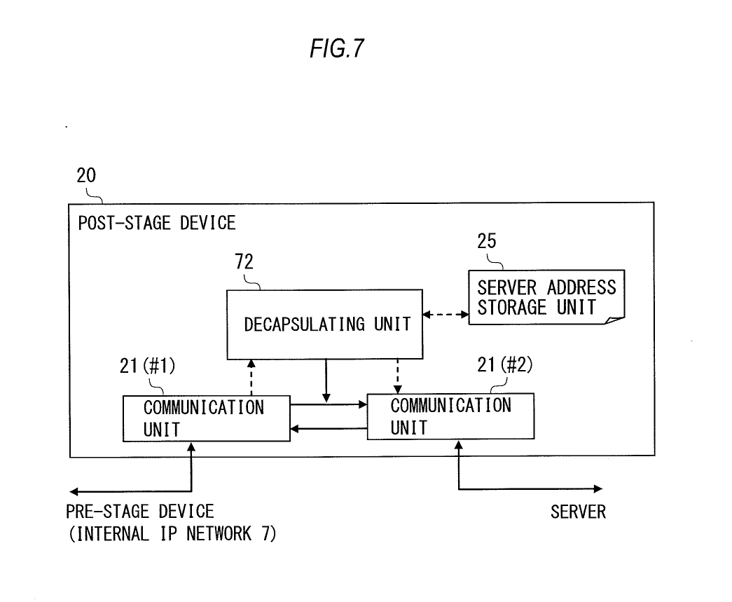

FIG. 7 is a block diagram illustrating an outline of the configuration of each post-stage device 20 in the second working example. Each of the post-stage devices 20 in the second working example has the same configuration. The post-stage device 20 in the second working example includes a decapsulating unit 72 in place of the destination address restoring unit 23 and the server address storage unit 25 in the first working example. Other units included in the post-stage device 20 are the same as those in the first working example. The decapsulating unit 72 is realized by a software component or a hardware component or a combination thereof, respectively (refer to Paragraph [Others]).

The decapsulating unit 72, when notified of receiving the packet from the communication unit 21(#1), decapsulates the received encapsulated packet. To be specific, the decapsulating unit 72 deletes one IP header from the received packet. The IP address of the post-stage device 20 itself is set in the “destination address” field of this deleted IP header. The decapsulated packet is the same as the packet transmitted from the client 1. That is, the address set in the “destination address” field of the decapsulated packet is the IP address (IP-s) of the server 30. The decapsulating unit 72 requests the communication unit 21(#2) to transmit the decapsulated packet.

### Operational Example

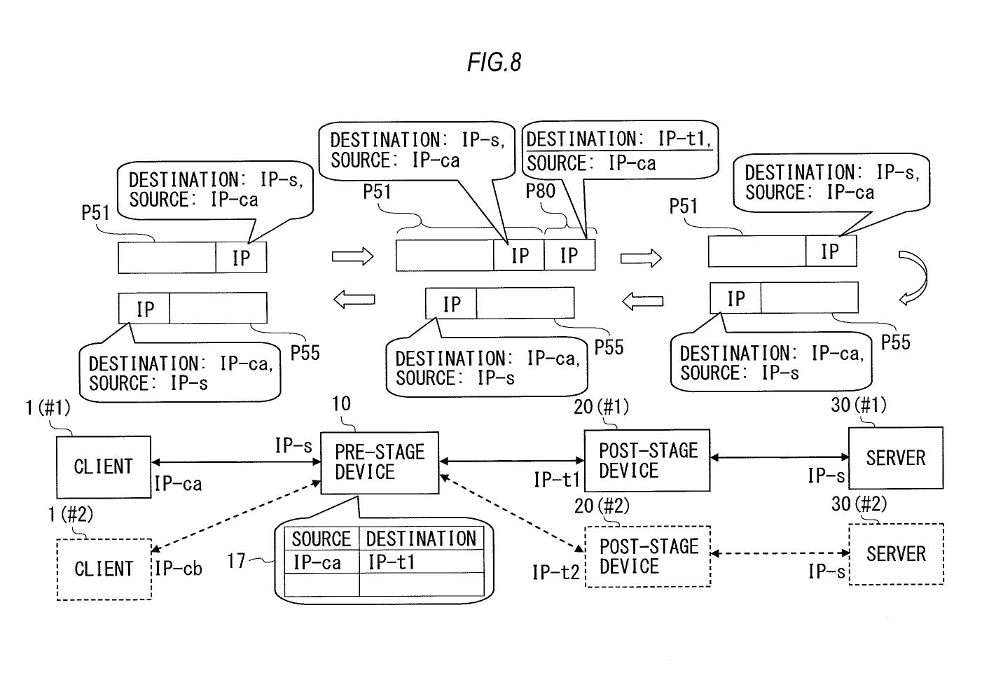

An operational example of the load balancing system in the second working example will hereinafter be described by use of FIG. 8. FIG. 8 is a diagram illustrating an example of the packets that are load-balanced by the load balancing system in the second working example. FIG. 8 depicts an example in such an instance that the client 1(#1) accesses and requests the server 30 for a predetermined process. It is assumed that the packet P51 transmitted from the client 1(#1) is the same as in the example of FIG. 4. Namely, the packet P51 has the IP header in which the IP address (IP-s) of the server 30 is set in the “destination address” field, and the IP address (IP-ca) of the client 1(#1) itself is set in the “source address” field.

In the pre-stage device 10, as discussed in the first working example, the server 30(#1) to which the packet P51 is distributed is determined based on the source IP address of the packet P51. The load balance processing unit 14 acquires the IP address (IP-t1) of the post-stage device 20(#1) connected to the determined server 30(#1). The load balance processing unit 14 sends the acquired IP address (IP-t1) of the post-stage device 20(#1) to the encapsulating unit 71.

Subsequently, the encapsulating unit 71 generates a new IP header P80 in which the IP address (IP-t1), sent from the load balance processing unit 14, of the post-stage device 20(#1) is set in the “destination address” field. The encapsulating unit 71 adds the generated IP header P80 to the packet P51 received by the communication unit 11(#1). As a result, the communication unit 11(#2) sends, to the internal IP network 7, the packet encapsulated with the IP header of which the destination address indicates the post-stage device 20(#1).

A packet (P80+P51) sent from the pre-stage device 10 is received by the post-stage device 20(#1) having the IP address (IP-t1) that is set in the “destination address” field of the IP header P80 added outside.

In the post-stage device 20(#2), when the communication unit 21(#1) receives the encapsulated packet via the internal IP network 7, the decapsulating unit 72 deletes the IP header P80 from the received packet. Consequently, the packet decapsulated by the decapsulating unit 72 becomes the same as the original packet P51. The communication unit 21(#2) transmits this decapsulated packet P51 to the communication line to which the server 30(#1) is connected. Only the server 30(#1) in the plurality of servers is connected to the communication unit 21(#2) of the post-stage device 20(#1), and therefore the packet P51 is received by the server 30(#1).

Through this operation, the packet received by the server 30(#1) executing the actual process becomes the very packet transmitted from the client 1(#1) similarly to the first working example.

Accordingly, the load balancing system in the second working example can acquire the same effects as those in the first working example. Namely, also in the second working example, it is possible to realize the general-purpose load balance utilizable in the variety of environments without depending on the applications and the protocols as well.

By the way, the response packet P55 transmitted to the client 1(#2) from the server 30(#2) is, without undergoing the address translation and the encapsulation in the same way as in the example of FIG. 4, delivered to the client 1(#2) via the post-stage device 20(#2) and the pre-stage device 10.

### Third Working Example

A third working example of the load balancing system given by way of the embodiment will hereinafter be described. The load balancing systems in the first and second working examples discussed above can be applied to a mode demonstrated by the third working example.

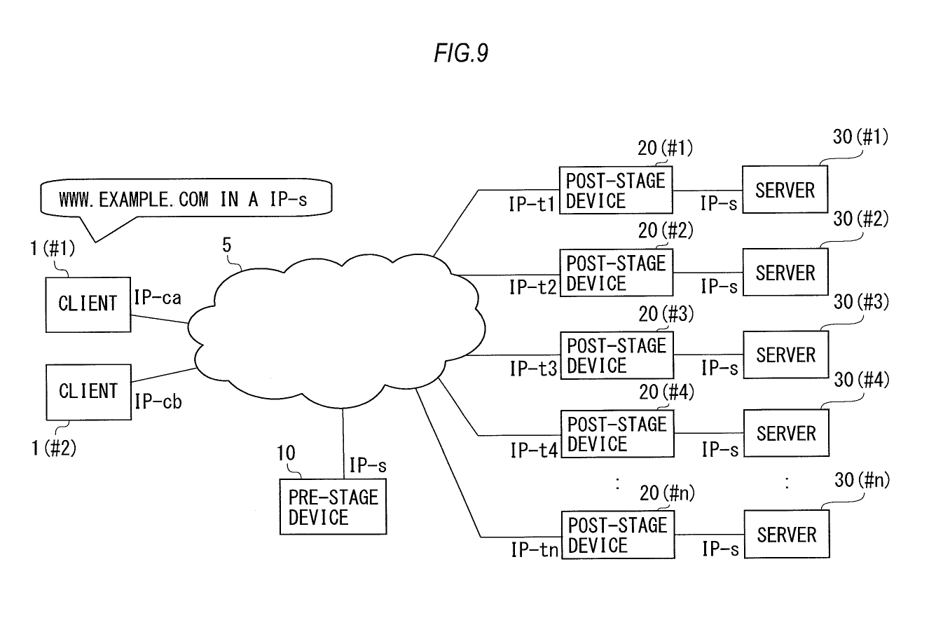

FIG. 9 depicts a system architecture of the load balancing system in the third working example. In the first and second working examples, the pre-stage device 10 is connected to the client 1 through the IP network 5, while the post-stage device 20 is not directly connected to the client 1 without through the pre-stage device 10. In the load balancing system in the third working example, both of the pre-stage device 10 and the post-stage device 20 are connected to the IP network 5 in the communication-enabled manner. Note that in the third working example, the communication mode between the pre-stage device 10 and the post-stage device 20 is different from that in the first working example, but other modes are the same as those in the first working example. The address format is also the same as that in the first working example.

[Device Configuration]

### [Pre-Stage Device]

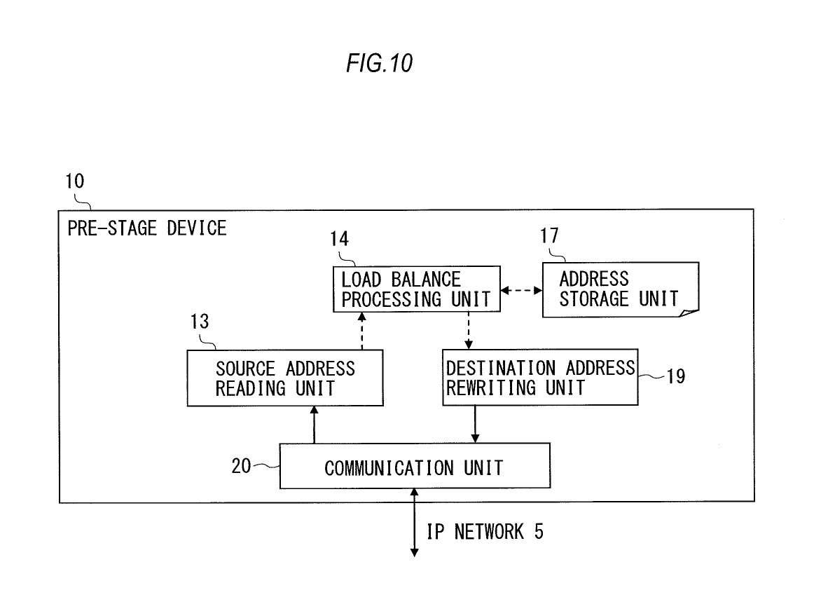

FIG. 10 is a block diagram illustrating an outline of a configuration of the pre-stage device 10 in the third working example. The pre-stage device 10 in the third working example includes a communication unit 90 as a substitute for the communication units 11(#1) and 11(#2) in the first working example. Other units included in the pre-stage device 10 are the same as those in the first working example. The communication unit 90 is realized by a software component or a hardware component or a combination thereof, respectively (refer to Paragraph [Others]).

The communication unit 90 may be sufficient if having at least one communication port connected to the IP network 5. The communication unit 90 receives the packet transmitted from the client and containing the setting of the IP address (IP-s) of the self-device (the pre-stage device 10) via this communication port. Further, the communication unit 90 transmits the packet of which the destination address is rewritten by the destination address rewriting unit 19 via this communication port. Note that the packet transmitted from the server 30 and relayed by the post-stage device 20 is sent to the client 1 without through the pre-stage device 10.

[Post-Stage Device]

The post-stage device 20 is the same as in the first working example except such a point that the communication port of the communication unit 21(#1) is connected to the communication line linked with the IP network 5.

The communication unit 21(#1) in the third working example receives the packet (with the destination address) being replaced by the IP address (e.g., IP-tn) of the self-device (the post-stage device 20) by the pre-stage device 10 through the IP network 5. Moreover, the communication unit 21(#1) in the third working example sends the packet received by the communication unit 21(#2) from the server 30 to the IP network 5.

### Operational Example

In the load balancing system in the third working example, the packet with its destination IP address being rewritten by the pre-stage device 10 into the address of the post-stage device 20 connected to the server 30 as the distribution target server, is delivered to the post-stage device 20 via the public IP network 5 such as the Internet. Further, the packet transmitted from the server 30 is sent to the IP network 5 through the post-stage device 20 and received by the client 1 through the IP network 5.

Thus, according to the third working example, the connection between the pre-stage device 10 and the post-stage device 20 is established by the public network, and hence the wide-area load balancing system can be realized. For example, the respective servers 30 for balancing (distributing) the loads can be disposed in the way of being targeted at a wide area.

A reason why the mode as in the third working example can be taken is that the packet received by the server 30 executing the actual process becomes the very packet transmitted from the client 1 in the load balancing according to the embodiment. For this reason, the response packet coming from the server 30 has no necessity of being compiled by the pre-stage device 10 and can be therefore delivered to the client 1 without through the pre-stage device 10.

According to the embodiment, the system mode as in the third working example can be taken, and it is therefore feasible to realize the general-purpose load balancing from a viewpoint of the system architecture. Further, the response packet transmitted from the server 30 is sent not through the pre-stage device 10, and hence the processing load on the pre-stage device 10 can be also reduced.

### Modified Example

The working examples discussed above did not particularly touch on a version of the IP address. This is because of not restricting the format of the IP address in any working examples discussed above. Moreover, each of the working examples discussed above may also be applied to a system in which IPv4 (Internet Protocol version 4) and IPv6 (Internet Protocol version 6) coexist.

In the case of this protocol-coexisting system, each of the pre-stage device 10 and the post-stage device 20 is provided with a unit for determining which IP version each of the packets received by the communication unit 11(#1) and the communication unit 21(#1) is based on. The destination address rewriting unit 19, the encapsulating unit 71, the destination address restoring unit 23 and the decapsulating unit 72 may be controlled so as to perform the address translation or the encapsulation corresponding to the determined IP version. Further, there may be utilized the IP version different from the IP version utilized for another network only between the pre-stage device 10 and the post-stage device 20. Furthermore, the header added for the encapsulation may involve taking a header corresponding to the IP version different from the IP address format utilized for another network.

Moreover, each of the working examples discussed above has demonstrated the instance of realizing the post-stage device 20 and the server 30 as the different devices, however, the post-stage device 20 and the server 30 establish a one-to-one connection with each other and may therefore be realized as one united device.

[Others]

### <Concerning Hardware Components and Software Components>

The hardware component is a hardware circuit such as an FPGA (Field Programmable Gate Array), an ASIC (Application Specific Integrated Circuit), a gate array, a combination of logic gates, a signal processing circuit and an analog circuit.

The software component is a component (segment) which realizes the process described above as the software but is not of a concept which limits languages, development environments, etc for realizing the software. The software component is exemplified such as a task, a process, a thread, a driver, firmware, a database, a table, a function, a procedure, a subroutine, a predetermined portion of program codes, a data structure, a matrix, a variable and a parameter. These software components are realized on a single memory or a plurality of memories (a single processor or a plurality of processors (e.g., CPU (Central Processing Unit), DSP (Digital Signal Processor), etc)).

It is noted that the embodiment discussed above does not limit the technique of realizing the respective processing units. The respective processing units described above may be configured as the hardware components, the software components or the combinations thereof by the techniques attainable by ordinary engineers in the field of the present technology.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A load balancing system comprising:
a pre-stage device to have setting of a predetermined server address; and
a plurality of post-stage devices to connect each with the pre-stage device in a communication-enabled manner and to connect respectively with server devices in which predetermined server addresses are individually set,
the pre-stage device including:
first receiving unit to receive original data transmitted from the client device and containing the setting of the predetermined server address as a destination address;
selecting unit to select any one of target post-stage devices from within the plurality of post-stage devices in a way that corresponds to an address of the client device which is set as a source address in the original data;
acquiring unit to acquire transfer data in which an address of the target post-stage device selected by the selecting unit on the basis of the original data is set as the destination address; and
first transmitting unit to transmit the transfer data,
the target post-stage device including:
second receiving unit to receive the transfer data, transmitted from the pre-stage device, in which an address of the target post-stage device itself is set as the destination address;
restoring unit to restore the transfer data received by the second receiving unit back to the original data in which the predetermined server address is set as the destination address; and
second transmitting unit to transmit the original data restored by the restoring unit to the server device connected to the target post-stage device itself.

2. The load balancing system according to claim 1, wherein the target post-stage device includes a first communication port to be connect with a communication line linked with the pre-stage device in order to realize the second receiving unit; and a second communication port to connect with a communication line linked with the server device connected to the target post-stage device in order to realize the second transmitting unit, and
when the second communication port receives the data transmitted from the server device connected to the target post-stage device itself, the received data is sent as it is from the first communication port.

3. The load balancing system according to claim 1, wherein the acquiring unit of the pre-stage device acquires the transfer data in a way that adds, to the original data, a new header in which the address of the target post-stage device is set as the destination address, and
the restoring unit of the target post-stage device makes restoration from the transfer data back to the original data by deleting the new header.

4. The load balancing system according to claim 2, wherein the pre-stage device and the target post-stage device are connected without through each other to a network to which each client device is connected in the communication-enabled manner,
the pre-stage device includes communication ports connected to the communication line linked with the network in order to realize the first receiving unit and the first transmitting unit, and
the target post-stage device sends the data transmitted from the server device connecting with the target post-stage device itself directly from the first communication port, thereby sending the data transmitted from the server device to the client device without through the pre-stage device.

5. A load balancing method to be executed by a system comprising: a pre-stage device to have setting of a predetermined server address; and a plurality of post-stage devices to connect each with the pre-stage device in a communication-enabled manner and to connect respectively with server devices in which predetermined server addresses are individually set,
the method making the pre-stage device: receive original data transmitted from the client device and containing the setting of the predetermined server address as a destination address; select any one of target post-stage devices from within the plurality of post-stage devices in a way that corresponds to an address of the client device which is set as a source address in the original data; acquire transfer data in which an address of the target post-stage device selected based on the original data is set as the destination address; and transmit the transfer data,
the method making the target post-stage device: receive the transfer data, transmitted from the pre-stage device, in which an address of the target post-stage device itself is set as the destination address; restore the received transfer data back to the original data in which the predetermined server address is set as the destination address; and transmit the restored original data to the server device connected to the target post-stage device itself.
